(19) United States
(12) Patent Application Publication
(10) Pub. No.: US 2011/0307412 A1
(43) Pub. Date: Dec. 15, 2011

(54) REUSABLE CAPACITY PLANNING SCENARIO TEMPLATES

(76) Inventors: Jerome Rolia, Kanata (CA); Mustazirul Islam, Rocklin, CA (US); Shiva Prakash SM, Bangalore (IN)

(21) Appl. No.: 12/815,203

(22) Filed: Jun. 14, 2010

(51) Int. Cl. G06Q 10/00; G06F 17/30; G06N 5/02; G06Q 50/00

(52) U.S. Cl. 705/348; 707/792; 707/781; 706/54; 707/E17.044

(57) ABSTRACT

Systems and methods are described for creating a reusable capacity planning scenario template. In one example, a method includes maintaining a system topology model of resources in a configuration management database. The topology model can include at least one computing device and at least one facility in which the computing device is used. The method can include assigning minimum and maximum constraint values to resources within the system topology. The constraints can be maximal or minimal limits on at least one of how, when, and where workloads may be used with regards to the resources. The method can further include identifying resources within the system topology model to include in the reusable capacity planning scenario template. The identified resources can be projected into a data mart. The reusable capacity planning scenario template can be created using a scenario planner based on the topology model and constraints of the identified resources in the data mart.

### BACKGROUND

Business services can be large applications, such as customer relationship management or electronic commerce applications, which can be used by enterprises. Such services can be important to the operation and success of the enterprises. Business services can be complex and have many application components, such as enterprise resource planning systems, databases, web application servers, and so forth. Business services are often deployed in data center facilities having dedicated physical servers and virtualized shared server pools.

Enterprises may sometimes use capacity modeling and planning to ensure appropriate system resources are available to handle the workloads of business services, to enable business capabilities, and to ensure target service levels are reached. Often enterprises may consider planning scenarios, such as: consolidating business services to shared resource pools (i.e., private clouds); re-allocating existing resources to better meet operational cost and performance goals; and evaluating the impact of outsourcing aspects of a service (e.g., to rely upon infrastructure-as-a-service or other services entirely).

Capacity planners for computing systems attempt to optimize business services on large and complex systems with a large number of server nodes which may be geographically dispersed. The workloads processed by the business services and the infrastructure in which business services are executed can change over time. Capacity planners can attempt to determine the impact of changes and what solutions to predicted performance issues will be most effective. Capacity planners often use models based on current system performance to predict how performance will change in response to anticipated or hypothetical changes to the workloads and infrastructure.

Current capacity planning strategies can involve a difficult and time-consuming process. A capacity planner may expend a great deal of time evaluating planning options and alternatives, only to subsequently discard those options or alternatives after discovering little or no advantage is gained by the options or alternatives. Capacity planners are also limited in the number of systems that can be planned for or the complexity of the systems due to the hands-on (e.g., manual) nature of current capacity planning strategies for creating and executing planning scenarios. Manual changes to capacity planning scenarios can also result in errors due to typological or logical mistakes by the capacity planner.

### BRIEF DESCRIPTION OF THE DRAWINGS

FIG. 1 is a block diagram of a system for reusable capacity planning scenario template creation in accordance with an example;

FIG. 2 is a block diagram illustrating usage of template PMDBs with a system PMDB to generate a planning scenario in accordance with an example;

FIGS. 3a-d are block diagrams illustrating uses of reusable templates in accordance with examples; and

FIG. 4 is a block diagram of a system for creating and using reusable capacity planning scenario templates in accordance with an example.

### DETAILED DESCRIPTION

Reference will now be made to the exemplary examples illustrated, and specific language will be used herein to describe the same. It will nevertheless be understood that no limitation of scope is thereby intended. Additional features and advantages will be apparent from the detailed description which follows, taken in conjunction with the accompanying drawings, which together illustrate, by way of example, features of reusable capacity planning scenario template creation.

Systems and methods are described for creating a reusable capacity planning scenario template. In one example, a method includes maintaining a system topology model of resources in a configuration management database. Without loss of generality, henceforth the term resources includes business service components, or Information Technology (IT), components and computing resources. The topology model can include at least one computing device and at least one facility in which the computing device is used. The method can include assigning minimum and maximum constraint values to resources within the system topology. The constraints can be maximal or minimal limits on at least one of how, when, and where workloads may be used with regards to the available resources or conversely how the available resources are used with regards to the workloads. The method can further include identifying resources within the system topology model to include in the reusable capacity planning scenario template. The identified resources and historical facts regarding the resources, e.g., CPU or memory measurements, can be projected into a data mart. The reusable capacity planning scenario template can be created using a scenario planner based on the topology model, constraints, and facts of the identified resources in the data mart.

Planning scenarios and templates as described herein can account for: a topology of business service application components and hardware infrastructure; constraints upon the services that may affect performance, reliability, and availability; service level requirements; constraints upon facilities such as power usage and space; software licensing; cost; and operational measures, such as resource usage and service levels. Topology and constraint information can be captured in a Configuration Management Database (CMDB), while usage information can be captured in monitoring repositories. Manually collecting usage information, combining the usage information with topology and constraint information, and reflect the usage information and/or the combination of usage information with the topology and constraint information in a planning scenario can be very time consuming and error prone according to prior systems and methods. Furthermore, information can change, increasing the difficulty in keeping planning models up-to-date in prior systems and methods. The creation of a reusable planning scenario as described herein can involve automation of the creation, evaluation and execution of planning scenario templates. Reusable planning scenario template creation, as described herein, can minimize effort expended for optimizing business services while also maximizing business goals (user experience, SLAs). The reusable planning scenario template creation can minimize operational costs (power, space etc.) while also addressing constraints. Support for creating and evaluating planning scenario templates can help enterprises better manage information technology (IT) environments.

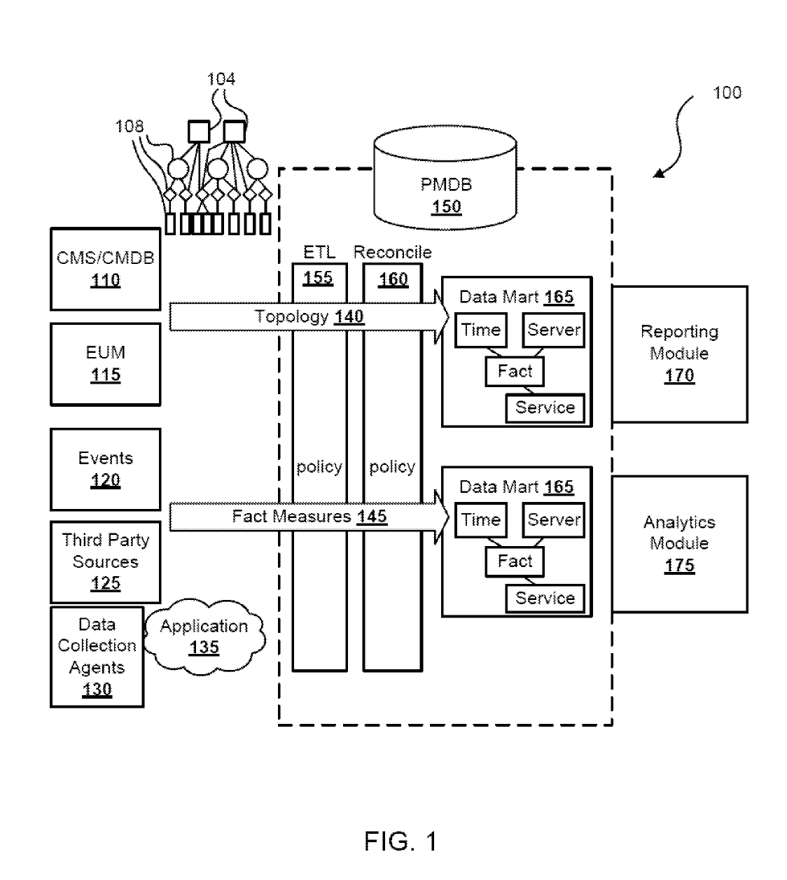

Referring to FIG. 1, a system 100 is shown for the creation of a capacity planning scenario template. The capacity planning scenario template can be created using a computing system and can be created for a computing system. A business service 104 can have various sources of information that describe the configuration, behavior, and resource usage of the service. As shown in FIG. 1, some of these sources of information can include: a configuration management system (CMS) 110, a universal configuration management database (uCMDB) or CMDB 110, an end-user manager reporting system for user level metrics (EUM) 115, an events log 120, and third-party sources 125. The CMS and uCMDB can provide topology 140 and service level information. In one aspect, the CMDB can maintain a topology model of available computing resources. The topology model can include computing devices 108 within the system topology. In one aspect, the topology model can also include facilities, e.g., rooms and buildings, in which the computing devices are used. The facilities information may comprise a facilities model within the topology model. The inclusion of facilities information with computing device topology information can allow for a capacity planner to not only plan according to projected system resource usage, or a projected number of users, but also according to how much space, power, etc. is available in a particular facility for upgrading to accommodate the projected system resource usage or projected number of users, for example.

As used herein, a “uCMDB” or “CMDB” is a repository that contains management information about business services. The information can be organized according to Business Service Models with elements named Configuration Items (CI). The CIs describe managed objects, their relationships, and constraints. A Topology Query Language (TQL) can provide an SQL-like language to interface with CMDB systems. CMDBs not only act as repositories for the most recent information about business service topologies but also provide support for change management, asset management and version control as information evolves. A “CMS” is a layer that federates and provides a single interface to multiple proprietary and heterogeneous 3rd party CMDBs. The terms “uCMDB” or “CMDB” are used herein to refer to what may be a federation of CMDBs accessed via the CMS.

The uCMDB 110 can include a dynamic discovery module (DDM). The DDM interacts with a variety of data collection agents 130 to continuously discover information about managed objects and their relationships and to reflect the information in CMDB. Automated discovery is useful in maintaining accurate and up-to-date information. Large systems can have millions of CI and updates to hundreds or more of CI per day. Additionally, IT services may update the CMDB when they make changes to the environment, and automated discovery can complement tracking of such changes.

Other data sources can provide measurements about the business service(s). The EUM 115, Events 120, and Third-Party Sources 125 shown in FIG. 1 are examples of these other data sources. Data sources can provide information such as workload information. The workload information can include data such as demand traces for a service on computing components or devices within the system. As a workload consumes computing resources, monitoring systems periodically measure resource demands, including but not limited to CPU and memory usage, and store the measured demand values in a demand trace. In one aspect, the measurements 145 about a business service may comprise a service model, and the measurements may comprise information or relationships about or between workloads and demand traces. The service model can also include other information relevant to licensing or service level agreements. As shown in FIG. 1, the third-party sources may comprise an application 135 and/or data collection agents 130 which operate to collect measurements about the business service(s) or measurements relevant to the business service(s).

The topology 140, service level information, and business service measurements 145 can be stored in a performance management warehouse 150, or performance management database (PMDB), within the context a business service's specific hierarchy. This enables the creation of business service optimization scenarios and reports on the results of analysis and/or on measurement data. The business service, or a business service model, may refer to system components such as hosts, virtual machines and so forth. The hosts and virtual machines can have unique identifiers. Monitoring systems produce demand traces for which can have the same unique identifiers as the hosts and virtual machines. When data is loaded into the PMDB via the ETL process a matching process can be performed to correlate the monitoring data from the monitoring system with particular hosts and/or virtual machines in the business service topology.

The PMDB 150 can automatically annotate each item of measurement data, or monitored data, with context information that is defined by each business service's own specific and possibly unique configuration items. For example, within the PMDB, a central processing unit (CPU) measurement can be associated with multiple tags that reflect a position of an application server associated with the CPU within the business service's topology. In prior solutions a CPU measurement may have only associated a virtual machine (that contains an application server) with a particular physical server. Categorizing data with multiple business service specific tags can provide a number of benefits. For example, all application components that are part of a business service can be selected for study in a planning scenario. Metrics such as CPU usage or power usage at several levels of abstraction (e.g., for a particular application server or for a business service as a whole) can be quickly summarized. Other information such as service level constraints on clusters of application servers can also be available for use in the planning scenario templates. Constraint information can specify a limit for resource utilization levels of each application server or provide that each application server reside on a separate physical server, for example. Other constraint examples include limits on at least one of how, when, and where a workload may be used with regards to available computing resources. Constraints can also include minimal or maximal limits on how, when, or where a workload or resource is used. Constraints projected, or uploaded, into the PMDB can be automatically found when creating planning scenario templates from the PMDB and need not be discovered or added manually by a capacity planner. If a business service changes, a corresponding planning model or template can be updated automatically using the tag-based approach. In one aspect constraints for workloads can be part of a workload model in the PMDB for managing and planning for the workloads in view of the constraints on workloads and/or computing devices.

In one example, some or all of the information for capacity planning templates is stored in the PMDB 150 and can be associated with tags or have tags assigned thereto. For example, tags can be assigned to computing resources within the topology model, to the workload model, to the facilities model, and to the service model. The tags can provide useful information, such as information about topology relationships, workload constraints, and service model services. The tags can provide specific information about particular system devices, such as a type of device, capabilities of the device, power consumption, compatibility, etc. The tags can also enable the system to easily account for constraints such as licensing or service level agreements. For example, a piece of software used in maintaining a business service may only be licensed for use on one or more specific machines. When creating a planning scenario template, a machine(s) limitation for usage of that software can easily be identified and planned for by identifying a tag associated with the software and/or machine(s).

Topology 140, measurement data 145, etc., can go through Extract Transform Load (ETL) 155 and reconciliation 160 processes to conform to the information in the PMDB 150. In other words, data can be extracted from outside sources, transformed to fit operational standards in the PMDB and loaded into the PMDB. The information loaded into the PMDB can be reconciled with information already in the PMDB. The PMDB can include user-configurable ETL and reconciliation policies for handling of topology, measurement data etc. In one aspect, the policies for handling of topology information can vary from policies used in handling measurement information. After ETL and reconciliation, the data can be stored in a data mart 165 within the PMDB. The PMDB can include a single data mart for storing all of the capacity planning data or multiple data marts, such as a data mart for topology information, a data mart for measurement data, etc. The data mart can record information about data stored in the data mart. For example, the data mart may store information such as the time the data was received, the server from which the data was received, a fact (such as topology or measurement data), a service associated with the fact, etc. This information can be associated with the data in the form of tags, as described above. Because these tags can provide information on constraints, as well as topology relationships and so forth, the tags may also be generally referred to as “constraint tags” herein.

The PMDB 150 can be used to generate a capacity planning scenario template for available computing resources based on the assigned constraint tags. For example, the topology model, the workload model, and the service model may be combined in the PMDB, and a capacity planning scenario template can be generated based on the combined models in the PMDB. A system administrator may be apprised of the capacity planning scenario via generation of a report, using a reporting module 170. An analytics module 175 can also provide an analysis of system performance of the generated capacity planning scenario template and may further provide a comparison with performance of the current system configuration or the configuration of another planning scenario template.

A business service may have many component workloads. Each workload may have certain objectives (e.g., utilization of allocation must remain below a threshold). The business service may have additional objectives (e.g., total power usage must be less than some objective). Workloads can have joint constraints (e.g., certain workloads must or must not be on the same physical server, limit on min/max number of replicates of an application component, component must reside on a host with a particular license, etc.). Facilities may have constraints on peak power, time of day power, limits on space, etc. The uCMDB and/or the PMDB can capture constraint information in the context of business services and facilities. Some of the information in the PMDB may comprise information about mechanisms to get resource demand traces for constituent workloads, relationships between workloads, resource allocation policies for workloads, licensing constraints, business service objectives, etc. The facilities model can capture constraints on power, space, and other aspects of infrastructure to be reflected in a reusable capacity planning scenario template.

The capacity planning scenario template generated from the PMDB may comprise the view of the system or a proposed system in the PMDB. For example, the template may comprise a topology, fact measurements, constraints, etc. The template may be based on actual or hypothetical topologies, measurements, etc. The template may comprise a planning scenario which can be evaluated by a user in comparison with other templates. A template may be created, for example, when a user creates a planning scenario. The template need not be implemented at the time the planning scenario is created. The template can be stored in the PMDB for later use. Templates can range from a very narrow to a very broad scope. For example, a template may describe a single hardware device, or only a portion of a device. A template may describe a single business service or a portion of a business service. Alternately, a template may describe a very large number of devices or business services. Configuration items within the template, such as server or network element, can be ready to be bound to other aspects of planning scenarios. Thus, a template may comprise a portion of a scenario to be bound with another scenario or template. An overall planning scenario can be created using one or more templates from the PMDB. A template created in one instance of a PMDB may be imported for use in another PMDB.

Scenario planning using reusable templates can enable faster and more efficient scenario planning. For example, a template may describe a new server. A customer may wish to analyze how the addition of the new server may impact the customer's business service. If a template describing the features of the new server is readily available, the customer can quickly and easily replace an existing server with the new server in the capacity planning system to run reports and analyze performance without having to learn all of the specific information about the new server or without having to re-describe an entire system. In another example, a user may already have a system using a pool of new servers. The user may wish analyze business service performance with an additional new server pool in the system. Because the system can be described using templates, a template for the new server pool may easily be identified, duplicated, and appended to the system configuration in a planning scenario to determine the affect of the additional new server on business service performance.

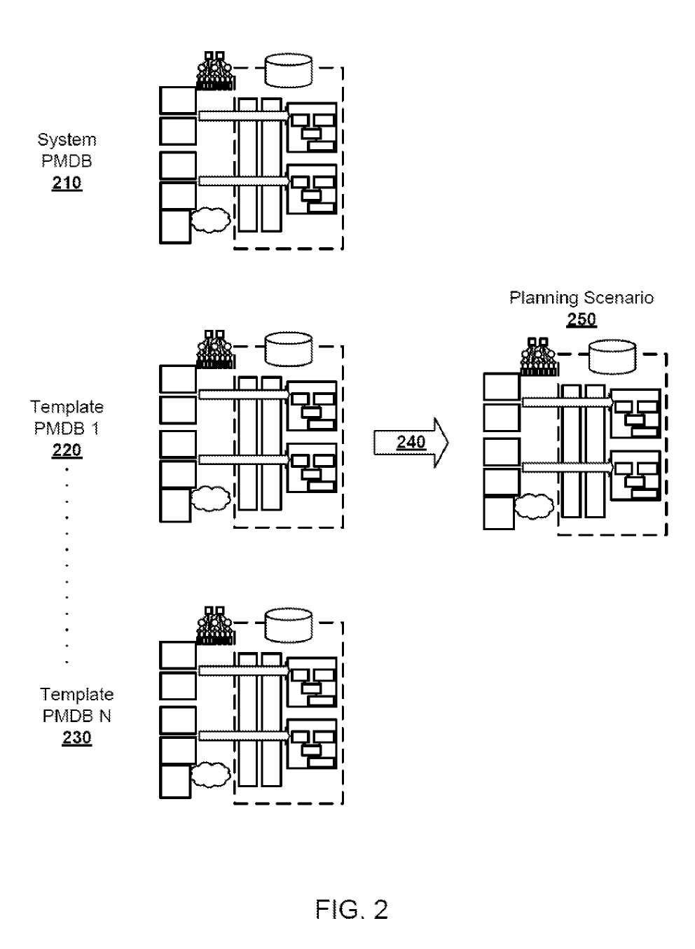

Referring to FIG. 2, use of the template in a planning scenario will be described. A system resource template 210 can be maintained. The system resource template may comprise the current system configuration. The system resource template can also include constraint tags for system hardware and services in the current system configuration. The system resource template can also include information about data usage, numbers of customers, and other such information which may be founding a planning scenario as created using the planning scenario system. In short, the system resource template can be a currently invoked planning scenario. For this reason the system resource template shown in FIG. 2, as well as other alternative or reusable templates also shown in FIG. 2, are each shown substantially similar in appearance to the system of FIG. 1. In one aspect, the system resource template may comprise a PMDB. As shown in FIG. 2, the system resource template comprises a System PMDB. The system PMDB may be comprise one template among many stored in a master PMDB configured for managing and creating PMDB templates. In one aspect, the system resource template and the reusable templates can be identified and distinguished by tags.

The master PMDB may comprise any number of reusable capacity planning scenario templates 220, 230. Like the system resource template, these reusable templates can include topology, resource usage information, constraint tags, and so forth. In one aspect, the reusable templates can include constraint tag for at least some of the same system hardware and services that are present in the system resource template.

A planning scenario 250 can be created by re-writing 240 at least one constraint tag in the system resource template 210 to refer to at least one constraint tag in one of the available reusable capacity planning scenario templates 220. For example, a tag identifying a reusable template as a reusable template can be rewritten to identify the reusable template as part of the system template. Re-writing the constraint tags in this manner can bind the reusable capacity planning scenario template(s) to the system resource template. As described above, a customer system PMDB can have tags for elements such as servers, specific types of services, etc. These tags can define associations between services, devices, and so forth. These associations can be replaced by using tags in a reusable template rather than the original system tags. Because the reusable template PMDB can have similar tags to the system PMDB, template infrastructure and services can easily be replaced in the original system infrastructure and services by rewriting the tags, as described. Re-writing the tags can cause the elements of the reusable template to be used in the system template as part of the hierarchy for facilities, business services, etc. Performance, power, and cost information computed in the planning scenario can also use the information from the templates rather than the original customer system. The impact of replacing one part of a system with another via templates may affect the interpretation of historical facts, such as CPU usage for example, when evaluating planning scenarios. In such cases, the affected facts may be modified to reflect the change. For example, the CPU demands may be decreased to reflect the impact of using faster CPUs.

An optimization can be used to solve for how best to achieve system goals. For example, a system goal may be best achieved by consolidating services or resources, or by adding additional hardware. The optimization can include, for example, a determination of how many new servers to add to achieve a predetermined performance benchmark. In one aspect, the scenario optimization can be performed using the bound reusable capacity planning scenario template and the system resource template. The optimization can include before and after comparisons made with respect to costs, space, power, or other metrics.

In one example, optimization may occur by altering a services and computing resource relationship. In other words, inclusion of new hardware, change in configuration of hardware or services, or rearrangement of which hardware is used for which service(s) or for a particular aspect of a service, etc., can improve service performance or decrease system resources used for the service. Therefore, the optimization may comprise testing various different configurations, arrangements, potential new hardware, etc. to determine an optimized configuration, or a configuration with a performance increase.

Also, the optimization can include solving “what if” scenarios. Solving a what if scenario may comprise solving for potential changes in future usage of the available computing resources. Solving a what if scenario may comprise solving for potential changes in number of users of the available computing resources. Solving a what if scenario may also comprise solving for potential changes in future available computing resources. Other examples of potential what if scenarios and optimizations that may be apparent to one having skill in the art are also contemplated. The PMDB or data mart can be updated with the optimization result. In one aspect, updating the data mart with the optimization or the result may comprise updating the constraint tags in the data mart. The updated data mart can report an optimized planning scenario to an administrator. For example, specific computing resource usage metrics can be reported to the administrator, or user. In one aspect, the reported information can be defined by the user and based on the constraint tags. In another aspect, a planning scenario may be reported to a user only when the performance of the scenario as compared with the current system configuration exceeds a predetermined threshold. For example, the predetermined threshold may be a minimal decrease or increase in system performance.

In one aspect, the updated data mart information can be used to implement the planning scenario. In another aspect, a capacity planning scenario template can be created based on the updated data mart. This capacity planning scenario template can be a further improvement on a previous capacity planning scenario template, or may be a different planning scenario template simply created based off the updated information. Storing solutions to optimizations and what if scenarios can make further reusable planning scenario template creation faster and more efficient by eliminating the need to solve the optimizations or what if scenarios again in the future for similar situations. A report may report on the results of many scenarios. Additionally, a reusable planning scenario template for some subsystem may be reused by a capacity planner for another system. This may reduce a minimal skillset or effort of the capacity planner for considering studies of the subsystem in the planner's own environment.

By using a PMDB for templates as described herein, branches of a system model can easily be replaced with similar branches defined in a template. A capacity planner need only be aware of what branches should be re-written rather than being aware of how to describe the contents of the template, thus simplifying capacity planning. Also, a capacity planner can try out many new planning scenarios quickly without expending a great deal of time and with a lower skill level than may be possible using previous approaches. Capacity planning is simpler and faster because information can be already captured in a template model and the user need have no a-priori knowledge of all the possibilities that can alternatively be presented via templates as described herein.

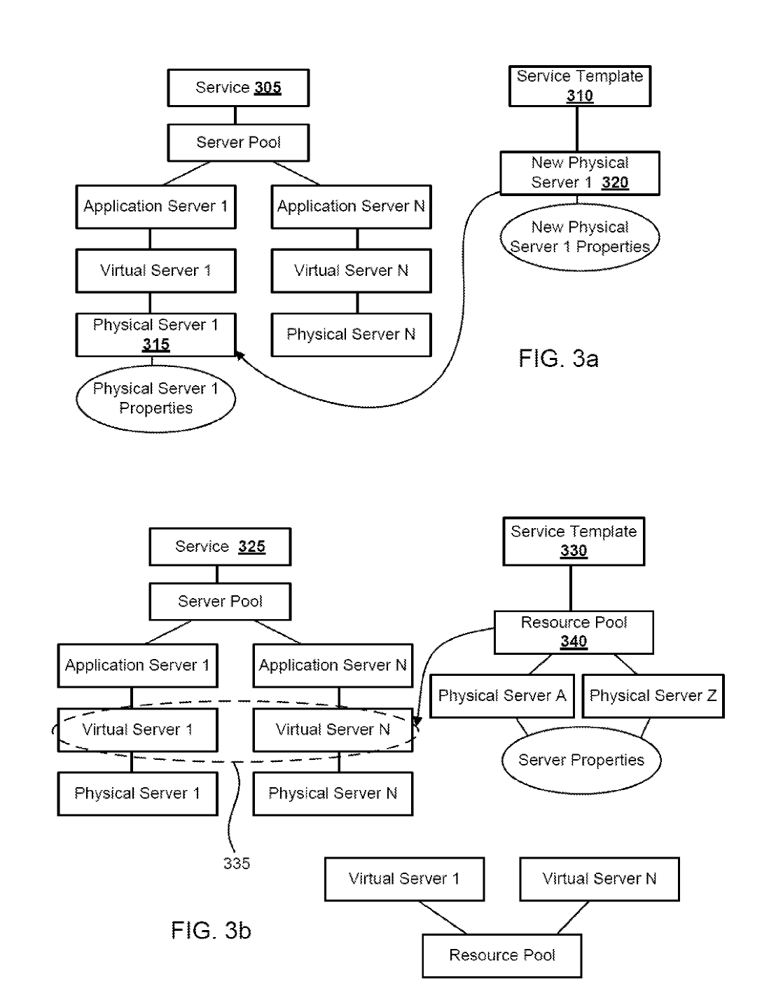

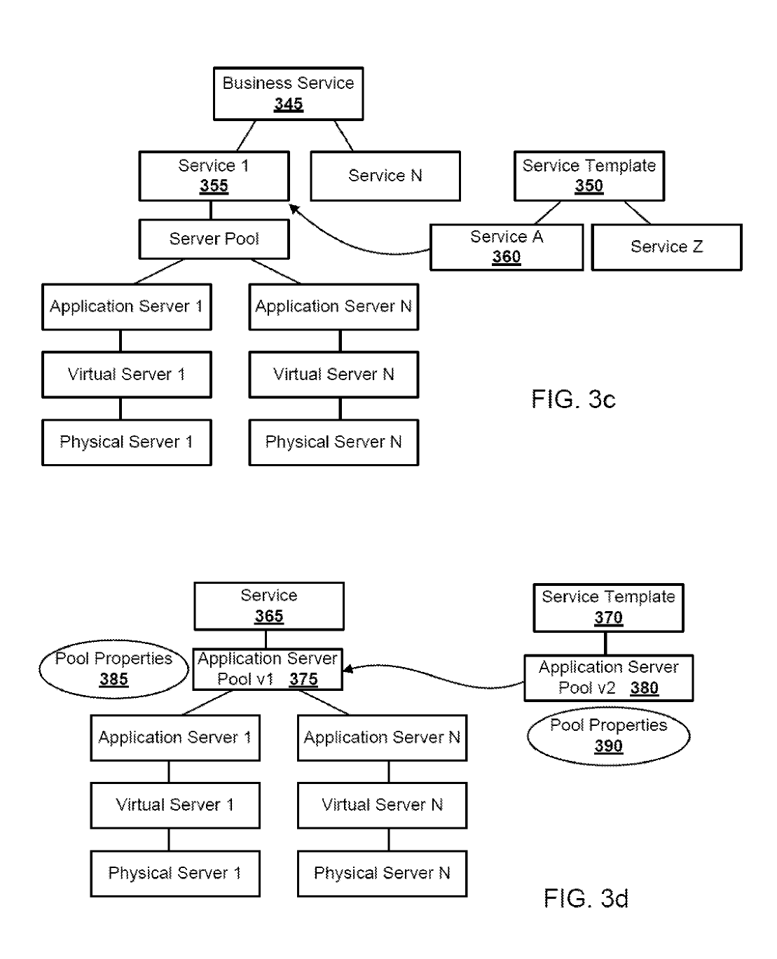

Example uses of templates in scenario planning will now be described with reference to FIGS. 3a-3d. Prior capacity planning solutions involved the creation of a model of the system for study. In these prior solutions, a capacity planner fully reflected proposed changes to a system in the model in order to be able to study the impact of the planning solution. This could be time consuming and in some instances a capacity planner may not have the experience or knowledge to adequately describe some of the proposed changes. Prior solutions have also involved fixed levels of abstractions that were considered in models. In contrast, with templates, as with other parts of capacity planning models based on PMDB, the capacity planner can design a capacity planning scenario that focuses on specific portions of the system rather than a fixed abstraction level of a model. Appropriate constraints for the existing system and the templates can be automatically discovered and rendered into the planning scenario.

Referring to FIG. 3a, an example use of a reusable template is shown in which a physical server 315 in a server pool for a business service 305 is replaced with a new physical server 320. In this example, physical server 1 can be selected via a GUI or other user interface. The new server can be selected from a service template 310 and the new server can be pasted into the service topology in place of physical server 1. Server properties may be available either for analysis by a user in determining whether to perform the replacement or for intelligent editing analysis, which will be described in further detail below. As a variant to this example, multiple physical (or virtual) servers may be selected for replacement and be replaced by one or more new servers.

Referring to FIG. 3b, an example use of a reusable template is shown in which virtual servers 335 are associated with a resource pool 340. In this example, virtual servers are selected from the service topology 325. A resource pool can then be selected from the service template 330. The virtual servers can then be associated with the resource pool. In the previous example, one server was replaced with another server. In this example, the resource pool is not replacing the virtual servers but is being associated with the virtual servers to become a resource for the virtual servers. For example, the resource pool may comprise multiple new servers A-Z. The resource pool can be used by the newly associated virtual servers in processing data or performing any variety of functions which may be improved through the association. The association of the resource pool with the virtual servers is shown in the bottom right portion of FIG. 3b.

Referring to FIG. 3c, an example use of a reusable template is shown in which an in-house business service 355 is replaced with a cloud-based service 360. In this example, a service (service 1) can be selected from the service topology 345. A cloud-based service (service A) which corresponds to the in-house service can be selected from the service template 350. Service A can be associated with Service 1 from the business service. This example demonstrates the replaceability of services as well as devices using the reusable templates.

Referring to FIG. 3d, an example use of a reusable template is shown in which an impact of a software upgrade to an application server pool is estimated. An application server pool 375 can be selected from the service topology 365. A new version of the server pool 380 can be selected from the service template 370. The new version can be pasted into the service topology in place of the old version. An analysis can be performed to predict the impact of the upgrade on performance, energy use, etc. In this example, the pool properties 385, 390 shown can include a scaling factor for resource demands. Thus, for example, the scaling factor for a 10% CPU performance degradation can be 1.1. This factor can be used to multiple old resource demands when doing analysis or reports to show performance impacts of upgrades.

In summary, as shown through FIGS. 3a-3d, tag re-writing can include selecting a service or hardware from the system resource template and replacing the service or hardware with a replacement service or replacement hardware from a reusable capacity planning scenario template. Also, tag re-writing can include associating a service or hardware from the system resource template with an additional service or additional hardware from the at least one reusable capacity planning scenario template. The system can be configured to estimating an impact on the system of binding the reusable capacity planning scenario templates to the system resource template.

As described above, the system can be configured to perform intelligent editing of cutting, pasting, or associating elements of a template to elements of a topology or service. The system can include an intelligent editing module. The intelligent editing module may comprise rules to restrict what cutting, pasting, or associations are permitted based on the types of selected items. In other words, the rules can be configured to guard against actions such as replacing a physical server with a database application, for example. In one aspect, the rules can be implemented based on the constraint tags associated with the service topology.

The intelligent editing module can enable a user to easily modify a service topology in an intelligent way. For example, the intelligent editing module may prompt a user to replace servers with a pool rather than just other servers, as may be appropriate. The intelligent editing module can base prompts and decision-making on common patterns for changes in templates. In another example, the reusable templates can include a description of how to make changes to the service topology. For instance, the template may include instructions to replace an item with an item of the same type, to accept virtual machines as parents, to accept virtual machines of servers as parents, to accept specified devices as children, etc.

The intelligent editing module can further invoke other existing technologies to determine whether two “application level services” are compatible. For example, the intelligent editing module may comprise an ontology for services. In one aspect, the ontology may be used to compare a Web Service Definition Language (WSDL) of the business service and a template service.

The intelligent editing module can further be configured to auto-recommend templates that match items selected by a user in a service topology.

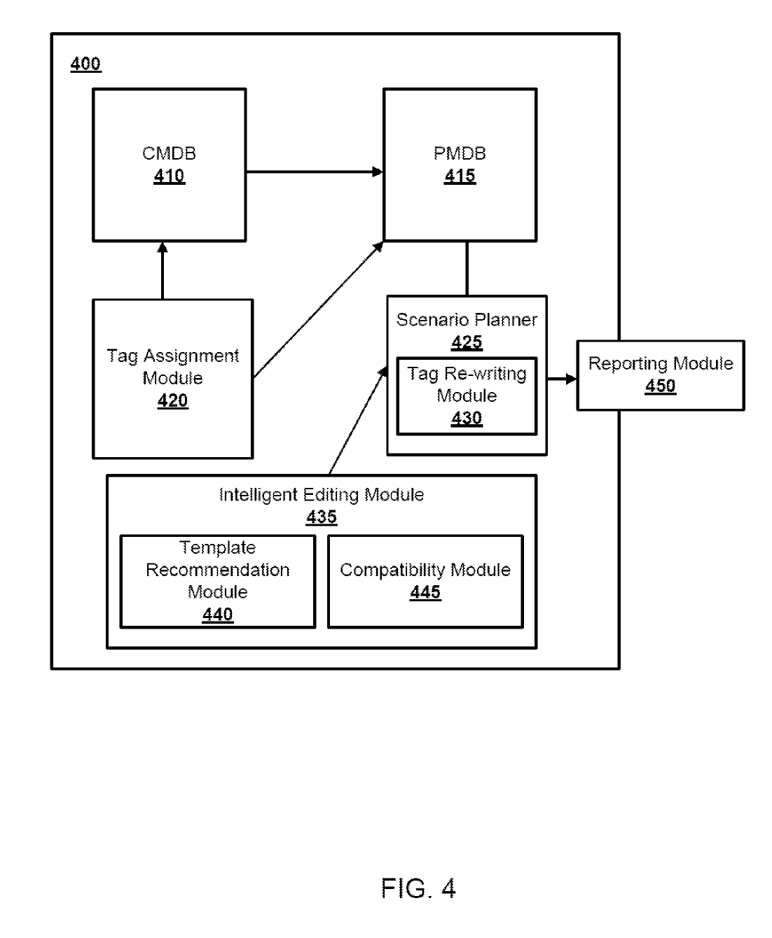

Referring now to FIG. 4, a system 400 is shown for creating and using a reusable capacity planning scenario template. The system is similar in many regards to the systems described above. The system can include a CMDB 410 for maintaining a system topology of devices, services, etc. The system can include a PMDB 415 in communication with the CMDB and configured to receive topology information from the CMDB. The topology information, as well as service measurement data or facts can be projected, or uploaded, to the PMDB. A constraint tag assignment module 420 can be used to assign constraint tags to the projected topology model and facts. As described above, the constraint tags may comprise information about topology relationships, computing device capabilities, services operated on the plurality of computing devices, and so forth. The system can include a scenario planner 425 for to creating a reusable capacity planning scenario template with constraints based on the topology model, facts, and constraint tags from the PMDB. The scenario planner can include a tag re-writing module 430. The tag re-writing module can be configured to re-write tags in a system resource template to refer to tags in a reusable scenario template to bind the templates together.

The system can include an intelligent editing module 435. In one aspect, the intelligent editing module can be configured to restrict re-writing of the constraint tags based on a type of constraint tag involved so that only constraint tags of a similar type can be re-written in place of an existing constraint tag of the similar type. The intelligent editing module can include a template recommendation module 440. The template recommendation module can be configured to automatically recommend a reusable capacity planning scenario template based on a selected constraint tag selected by a user. The intelligent editing module can also include a compatibility module 445. The compatibility module can be configured to determine a compatibility of a first service in the system resource template and a second service in the reusable capacity planning scenario template using an ontology.

The system can also include a reporting module 450. Among preparing a presenting reports as described above, the reporting module can be configured to compare a system configuration before and after rewriting the constraint tags (or binding the templates) and report the impact of the configuration change to a user.

Using the systems and methods herein, a capacity planner can explore upgrades and new approaches to implementing parts of system without having to fully describe all of the changes to the system in a model. The capacity planner need only re-write tags used to bind the existing view of the system with a template which fully describes the remaining system changes.

Some of the functional units described in this specification have been labeled as modules or engines, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

Also within the scope of an example of the systems and methods herein is the implementation of a program or code that can be stored in a machine-readable medium to permit a computer to perform any of the methods described above.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

While the forgoing examples are illustrative of the principles of reusable capacity planning scenario template creation in one or more particular applications, it will be apparent to those of ordinary skill in the art that numerous modifications in form, usage and details of implementation can be made without the exercise of inventive faculty, and without departing from the principles and concepts described herein. Accordingly, no limitation is intended, except as by the claims set forth below.

1. A method for creating a reusable capacity planning scenario template, comprising:
maintaining a system topology model of resources in a configuration management database, wherein the topology model includes at least one computing device and at least one facility in which the computing device is used;
assigning minimum and maximum constraint values to resources within the system topology, wherein the constraints comprise maximal or minimal limits on at least one of how, when, and where workloads may be used with regards to the resources;
identifying resources within the system topology model to include in the reusable capacity planning scenario template;
projecting the identified resources into a data mart; and
creating the reusable capacity planning scenario template using a scenario planner based on the topology model and constraints of the identified resources in the data mart.

2. A method in accordance with claim 1, wherein creating the reusable capacity planning scenario template comprises creating a template configured to replace only a portion of the system topology model.

3. A method in accordance with claim 1, further comprising identifying potential changes in the resources, and wherein creating the reusable capacity planning scenario template comprises creating the reusable capacity planning scenario template based on the identified potential changes in the resources.

4. A method in accordance with claim 1, further comprising identifying potential changes in workloads or services, and wherein creating the reusable capacity planning scenario template comprises creating the reusable capacity planning scenario template based on the identified potential changes in the workloads or services.

5. A method in accordance with claim 1, further comprising re-writing at least one constraint tag in the reusable capacity planning scenario template to refer to at least one constraint tag in a different reusable capacity planning scenario template to bind the different reusable capacity planning scenario templates to the reusable capacity planning scenario template.

6. A method in accordance with claim 5, wherein re-writing at least one constraint tag further comprises selecting a service or hardware from the reusable capacity planning scenario template and replacing the service or hardware with a replacement service or replacement hardware from the different reusable capacity planning scenario template.

7. A method in accordance with claim 5, wherein re-writing at least one constraint tag further comprises associating a service or hardware from the reusable capacity planning scenario template with an additional service or additional hardware from the different reusable capacity planning scenario template.

8. A method for using a reusable capacity planning scenario template, comprising:
maintaining a system resource template, the system resource template including constraint tags for system hardware and services, wherein the constraints comprise limits on at least one of how, when, and where workloads may be used with regards to the system hardware and services;
maintaining at least one reusable capacity planning scenario template including constraint tags for at least some of the same system hardware and services present in the system resource template;
re-writing at least one constraint tag in the system resource template to refer to at least one constraint tag in one of the at least one reusable capacity planning scenario template to bind the one of the at least one reusable capacity planning scenario templates to the system resource template; and
performing a scenario optimization of system resources using the bound reusable capacity planning scenario template and the system resource template.

9. A method in accordance with claim 8, wherein re-writing at least one constraint tag further comprises selecting a service or hardware from the system resource template and replacing the service or hardware with a replacement service or replacement hardware from the at least one reusable capacity planning scenario template.

10. A method in accordance with claim 8, wherein re-writing at least one constraint tag further comprises associating a service or hardware from the system resource template with an additional service or additional hardware from the at least one reusable capacity planning scenario template.

11. A method in accordance with claim 8, further comprising estimating an impact on the system of binding the one of the at least one reusable capacity planning scenario templates to the system resource template.

12. A method in accordance with claim 8, further comprising restricting re-writing of the at least one constraint tag using an intelligent editing module based on a type of constraint tag involved so that only constraint tags of a similar type can be re-written in place of an existing constraint tag of the similar type.

13. A method in accordance with claim 8, wherein re-writing at least one constraint tag further comprises selecting at least one constraint tag to be re-written, and the method further comprises automatically recommending a reusable capacity planning scenario template based on the selected at least one constraint tag.

14. A method in accordance with claim 8, further comprising projecting resource usage with the system resource template, and modifying the projected resource usage based on the re-writing of at least one constraint tag.

15. A system for creating and using a reusable capacity planning scenario template, comprising:
a configuration management database a performance management database a constraint tag assignment module configured to assign constraint tags to the projected topology model and facts, wherein the constraint tags comprise information about topology relationships, computing device capabilities, and services operated on the plurality of computing devices; and
a scenario planner configured to create a reusable capacity planning scenario template with constraints based on the topology model, facts, and constraint tags from the performance management database.

16. A system in accordance with claim 15, further comprising an intelligent editing module configured to restrict re-writing of the constraint tags based on a type of constraint tag involved so that only constraint tags of a similar type can be re-written in place of an existing constraint tag of the similar type.

17. A system in accordance with claim 15, further comprising a tag re-writing module configured to re-write at least one constraint tag in the reusable capacity planning scenario template to refer to at least one constraint tag in at least one different reusable capacity planning scenario template to bind the at least one different reusable capacity planning scenario template to the reusable capacity planning scenario template.

18. A system in accordance with claim 15, further comprising a template recommendation module configured to automatically recommend a reusable capacity planning scenario template based on a selected constraint tag selected by a user.

19. A system in accordance with claim 15, further comprising a reporting module configured to compare a system configuration before and after rewriting the constraint tags (or binding the templates) and report the impact of the configuration change

20. A system in accordance with claim 15, further comprising a compatibility module configured to determine a compatibility of a first service in the system resource template and a second service in the reusable capacity planning scenario template using an ontology.
